(19) United States
(12) Patent Application Publication
(10) Pub. No.: US 2011/0265655 A1
(43) Pub. Date: Nov. 3, 2011

(54) Combination Filter

(75) Inventors: Hans-Michael Schuster, Haan (DE); Sylke Waldschmidt-Schroer, Erkrath (DE)

(73) Assignee: Donaldson Filtration Deutschland GmbH, Haan (DE)

(21) Appl. No.: 13/144,619

(22) PCT Filed: Jan. 15, 2010
(86) PCT No.: PCT/EP10/00208

§ 371 Date: Jul. 14, 2011

(30) Foreign Application Priority Data
Jan. 15, 2009 (DE) 10 2009 005 158.9

(51) Int. Cl. B01D 50/00; B01D 46/10; B01D 53/02

(52) U.S. Cl. 96/134; 55/318; 55/495

(57) ABSTRACT

The invention relates to a combination filter with a housing having an inlet and an outlet for a fluid to be cleaned, a coalescence filter element and a processing filter element, wherein the filter elements are arranged in the housing such that after the fluid has entered the housing through the inlet, the fluid flows through the filter elements in the described sequential order, before the fluid exits the housing again through the outlet.

The invention relates to a combination filter which has at least one coalescence filter element and a processing filter element.

Such combination filters are used in conventional applications, for example in connection with compressors, to filter oil aerosols and oil vapor which intermixes with compressed air during operation of the compressor. For example, damage to downstream machines or adverse effects on processes where the compressed air is used can thus be prevented.

It is known in the art to use so-called coalescence filters for the separation of oil aerosols. Coalescence filters typically have filter elements made of a relatively permeable fiber fabric through which the compressed air to be cleaned flows. The oil aerosols strike the filter fibers where they get caught due to their adhesive effect. The various oil aerosols caught in the coalescence filter element coalesce into larger drops, which in turn accumulate in the lower portion of the filter element due to their weight, drip down and are caught in catch vessels.

For example, oil vapor adsorber filters are used as processing filter elements. These are used to separate oil vapor not previously separated by the coalescence filter element. Such oil vapor adsorber filters frequently include an activated charcoal element, wherein the activated charcoal particles bind the oil vapor contained in the compressed air.

It is also known in the art to combine activated charcoal filters with a downstream dust filter to filter from the compressed air charcoal particles entrained by the compressed air when the flowing through the activated charcoal element.

Conventionally, the individual filter elements, i.e., coalescence filter, oil vapor adsorber filter and optionally particle filter are integrated sequentially in the compressed air supply line as separate components. This is not only intended to simplify the design and thereby lower the manufacturing costs of the individual filters, but more particularly, the filter elements are integrated separately in the compressed air supply lines so that the individual filter elements can be exchanged only when needed, i.e. at the end of the service life of the respective filter element. This is intended to keep the cost for utilizing the filter low. The separate integration of the filter elements in the compressed air supply lines, however, requires more space and increases maintenance costs.

Based on this state of the technology, it was an object of the invention to provide an improved filter which is particularly compact and/or easy to service.

This object is attained by a combination filter according to the independent claim 1. Advantageous embodiments of this combination filter are recited in the dependent claims 2 to 6 and described in the following detailed description of the invention. The independent claim 8 relates to an advantageous coalescence filter element for use in a combination filter according to claim 1. Another advantageous embodiment of this coalescence filter element is recited in the dependent claim 9.

A combination filter according to the invention includes at least one housing with an inlet and outlet for a fluid to be cleaned (in particular compressed air), as well as a coalescence filter element and a processing filter element, which are arranged in the housing such that the fluid flows through the combination filter, after the fluid has entered the housing through the inlet, in the described sequential order, before the fluid exits the housing again through the outlet.

According to the invention, the at least two filter elements are integrated in a single housing which may be constructed of several parts, thereby producing a compact unit of the combination filter with several filter elements. Such combination filter according to the invention can advantageously have a compact shape and a particularly small installation height. Another essential advantage can also be the ease of handling, because only a single combination filter according to the invention needs to be integrated in the fluid supply lines. A combination filter according to the invention is therefore particularly suited, for example, as a compact processing unit for small compressors (for example, for painting) or for conditioning compressed air in high-quality head ends of compressed air systems (e.g., supply of a measuring device/laser cutting system), with the possibility to separately exchange each of the filter elements is less important, while it is more desirable to connect only a single, particularly compact combination filter in immediate vicinity of the end user.

According to the invention, “processing element” is referred to as a filter element which produces a cleansing effect through physical or chemical interaction with the fluid to be cleaned and which more particularly removes particles (solid, liquid and/or gaseous) from the fluid. The processing element can be filled with different adsorbers and/or catalysts for removing from the gas flow, in particular, various gas/vapor components (e.g., hydrocarbons, CO, CO₂, SO₂, NOₓ, O₂, etc.). Depending on the employed material, these can be granular material, sintered shaped parts, monoliths or fibers in form of a fabric or fiber mixtures (bound or free).

The coalescence filter element can preferably be constructed of a high-efficiency deep-bed filter medium of a type typically used generally in coalescence filtration and particularly as a pre-stage for adsorber-type gas or compressed air processing stages (oil vapor adsorber, dryer, stages for CO and/or CO₂ removal). The residual oil content in aerosol form should not exceed 0.05 mg/m³ (measured according to ISO 8573-2, method B2) downstream of the coalescence filter, to prevent blocking of the pores of the adsorber, for example, by oil droplets in the downstream processing module.

Preferably, the processing filter element can be an oil vapor adsorber filter element and particularly preferred, an activated charcoal filter element. An activated charcoal filter element typically ensures good separation of oil vapor from, for example, compressed air at low cost.

Preferably, the coalescence filter element can be implemented as a plane filter, which can be space-savingly integrated in the housing of the combination filter and which has a particularly low installation height.

In a particularly preferred embodiment of the combination filter of the invention, a particle filter element can be additionally arranged downstream of the processing filter element and integrated in the housing of the combination filter. Such particle filter element can further improve the quality of filtering the fluid, in that for example activated charcoal particles, which can be released from the processing filter element implemented as activated charcoal filter element when the fluid flows through, are filtered out.

Filter materials for the particle filter element are, in particular, sintered materials (e.g., PE, bronze, PP, etc.), but also fiber filters (glass fiber paper, needle-shaped polymer fibers, etc.). The pore width can be varied over a wide range (e.g., over a range of 0.01 μm to 100 μm) and more particularly depends on the desired nonexistence of particles of the gas downstream of the combination filter.

The particle filter element can preferably also be implemented as a plane filter element which can also be space-savingly integrated in the housing of the combination filter and which has a particularly low installation height.

Preferably, the coalescence filter element is arranged in the housing as the lowest filter element, wherein the fluid flows through the housing from the top to the bottom, and wherein the fluid can be diverted before flowing through the following processing filter element. With this preferred arrangement of the coalescence filter element, the particles filtered by this filter element and in particularly oil aerosols can directly drip into a catch region, which is located directly below the coalescence filter element, or which can alternatively be formed by the housing of the combination filter.

In another preferred embodiment of the combination filter according to the invention, one, several a particularly preferred all the filter elements can be integrated in an insert, which is preferably interchangeably arranged in the housing of the combination filter. In this way, the filter elements, which are designed as wear elements, can be combined in an easily interchangeable insert which can optionally be manufactured of plastic and then inserted into the housing, which can be made of metal, and particularly be cast, and which does not represent a wear part. All additional components of the combination filter, which are not wear parts, can preferably be integrated in the housing, for example a drainage valve, optionally with fill level sensor, a difference pressure measurement system, etc. This design of the combination filter of the invention can be manufactured at low cost and has low maintenance requirements.

A coalescence filter element for use with a combination filter according to the invention can have a tubular shape, with a housing jacket having a first open end that is closed by a coalescence filter material, and another open end that is configured as a fitting for attachment to a processing filter element, wherein the two open ends are separated from one another by a diagonal separation wall. Such coalescence filter element has a very compact shape.

In a particularly preferred embodiment, the coalescence filter material of the coalescence filter element is configured as a plane filter with a filter plane that is arranged parallel to the plane formed by the fitting. In this way, a particularly compact coalescence filter element can be constructed.

The invention will now be described in more detail with reference to exemplary embodiments illustrated in the drawings.

The drawings show in:

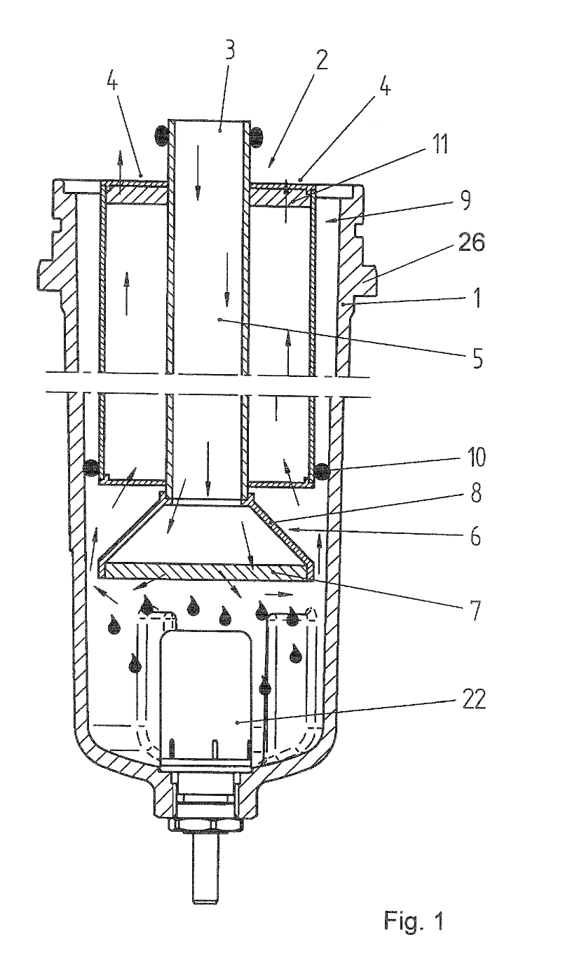

FIG. 1: in a longitudinal cross-section, a first embodiment of a combination filter according to the invention,

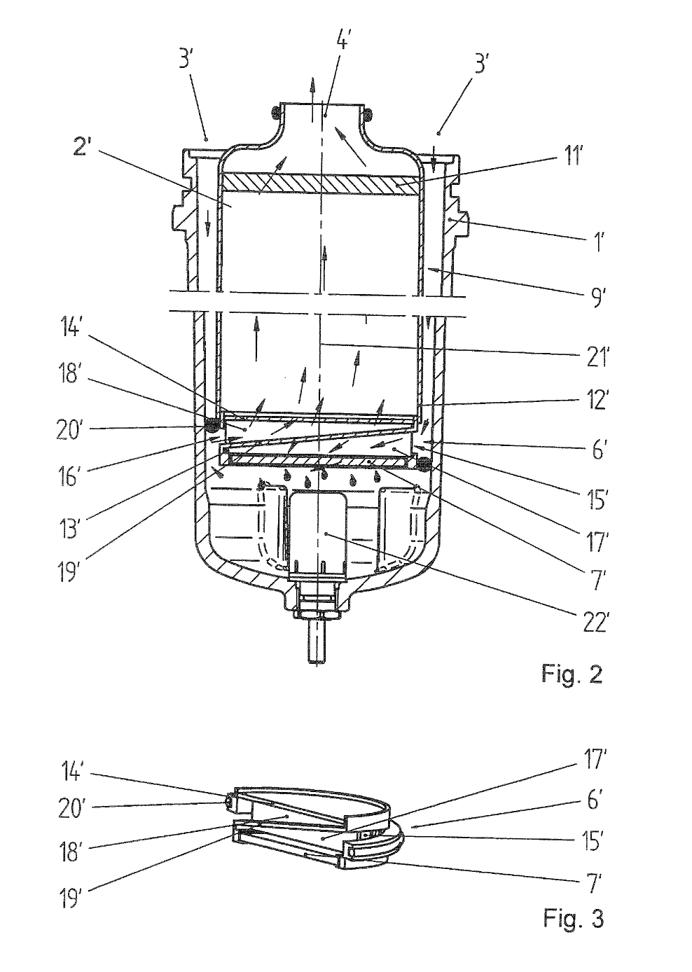

FIG. 2: in a longitudinal cross-section, a second embodiment of a combination filter according to the invention,

FIG. 3: an isometric cross-sectional view of the coalescence filter element used with a combination filter of FIG. 2, and

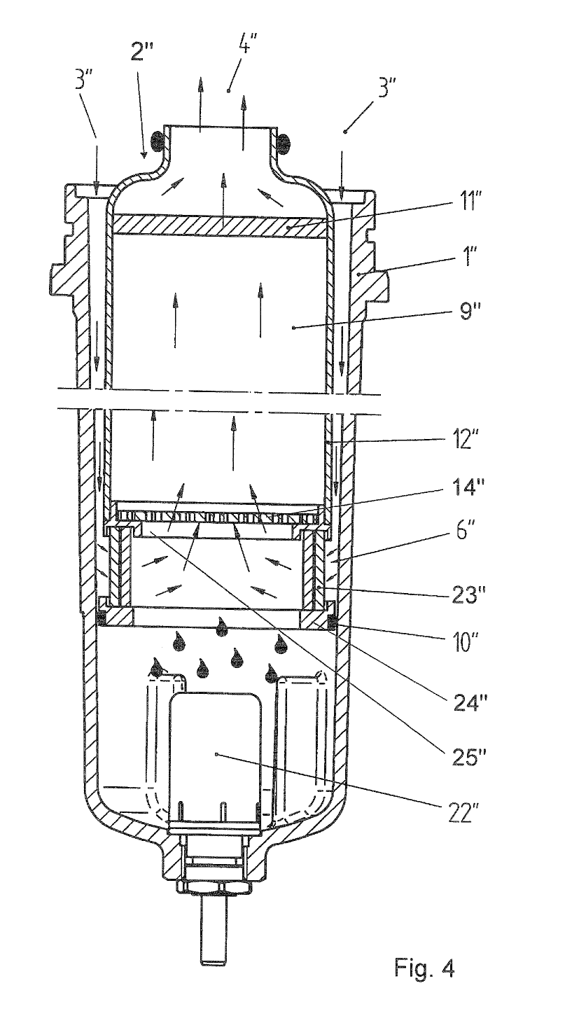

FIG. 4: in a longitudinal cross-section, a third embodiment of a combination filter according to the invention.

FIG. 1 shows a first embodiment of a combination filter according to the invention. The combination filter includes a housing, with only a housing base 1 thereof being illustrated. The housing base 1 has a circular cross-section, wherein the housing base has at its lower end an opening with a small diameter, in which a drainage valve is integrated. The open upper end of the housing base is configured for connection to an upper housing section (not illustrated), to which it is connected by a bayonet lock. The housing base has corresponding catch elements 26. An insert 2 is arranged in the housing base 1. An inlet channel 3 and an annular outlet channel 4 are integrated in the insert 2, which overlap with corresponding inlet and outlet openings in the upper housing section, by which the combination filter is connected to a supply and drainage line of a compressed air supply. The centrally arranged inlet channel 3 for the compressed air transitions directly into a submerged tube 5 arranged centrally inside the housing 1, through which the compressed air is guided to a coalescence filter element 6 arranged in the lower section of the housing 1.

The coalescence filter element 6 includes a circular plane filter 7 with an outside diameter that is slightly smaller than the inside diameter of the housing base 1 at that location. The compressed air exiting the submerged tube 5 is guided through a funnel-shaped housing part 8 of the coalescence filter element 6 to the plane filter 7, whereby oil aerosols contained in the compressed air are trapped when passing through the filter material of the plane filter 7, and coalesce into larger oil droplets and drip down from the plane filter 7 due to gravity. The oil droplets are collected in the housing base 1 which is closed off at the bottom.

The drainage valve 22, which is provided with a fill level sensor, is integrated in the lower part of the housing base 1. When the oil filtered from the compressed air by the coalescence filter element 6 reaches a certain fill level, the fill level sensor causes the drainage valve 22 to open, whereby the oil can be discharged from the combination filter.

After the compressed air has passed through the coalescence filter element 6, the compressed air is diverted and flows once again upward through the annular gap formed between the coalescence filter element 6 and the housing bottom 1. The compressed air thereafter flows into an annular activated charcoal filter element 9 which is filled with activated charcoal particles (not shown) which filter the oil vapor contained in the compressed air. The annular gap is sealed with a seal 10 to prevent the compressed air from bypassing the annular gap between the activated charcoal filter element 9 and the housing base 1.

The upper opening of the annular activated charcoal filter element 9 is closed off by a particle filter element 11 formed as an annular plane filter, which catches the carbon particles that are released when the compressed air flows through the activated charcoal filter element 9 is caught and filters the released carbon particles from the compressed air.

The cleaned compressed air is, after flowing through the particle filter element 11, again discharged through the outlet channel 4 integrated in the insert 2.

FIG. 2 shows an alternate embodiment of a combination filter according to the invention. This combination filter has also a cylindrical housing base 1′ which is closed off at the bottom. A filter insert 2′ having an outlet channel 4′ is arranged in the housing base; an annular inlet channel 3′ is formed between the filter insert and the upper edge of the housing bottom 1′. The combination filter can be connected to the supply lines of a compressed air supply via the inlet channel 3′ and the outlet channel 4′ and corresponding inlet and outlet openings in the unillustrated upper housing section. The compressed air is introduced into the combination filter through the inlet channel 3′ and flows through an annular gap formed between the housing 1′ and a cylindrical housing component 12′ of the activated charcoal filter element 9′ towards the lower section of the combination filter, where the coalescence filter element 6′ is arranged.

The coalescence filter element 6′ has also a cylindrical housing component 13′, whose lower end is closed off with coalescence filter material implemented as a plane filter 7′. The cylindrical housing component 13′ of the coalescence filter element 6′ is connected via the upper opening directly with the housing component 12′ of the activated charcoal filter element 9′ located above, with a support disk 14′ made of felt preventing the activated charcoal particles (not shown) from falling into the coalescence filter element 6′. The compressed air supplied through the annular space between the activated charcoal filter element 9′ and the housing base 1′ flows into the housing component 13′ of the coalescence filter element 6′ through first lateral inlet openings 15′, and then flows through the plane filter 7′, thereby filtering oil aerosols from the compressed air. The compressed air is then deflected and flows back into the coalescence filter element 6′ through second lateral outlet openings 16′ disposed in the housing component 13′ of the coalescence filter element 6′, whereafter it flows through the upper opening of the housing component 13′ into the activated charcoal filter element 9′.

The oil vapor contained in the compressed air is mostly filter out when flowing through the activated charcoal filter element 9′, with the activated charcoal particles binding the oil vapor.

The upper end of the activated charcoal filter element 9′ is closed off by a particle filter element 11′, which filters out the activated charcoal particles entrained in the compressed air flowing through the activated charcoal filter element 9′.

After the compressed air has passed through the particle filter element 11′, the compressed air is discharged from the combination filter through the outlet channel 4′.

The coalescence filter element 6′ used with the combination filter of FIG. 2 has a compact and space-saving construction, whereby as a result of the separation of the interior space, which is delimited by the cylindrical housing component 13′, into an inlet space 17′ and an outlet space 18′ by a diagonal separation wall 19′, almost the entire cross-sectional surface of the combination filter element 6′ can be used for the coalescence filter material configured as a plane filter 7′ in spite of the compact construction. The separation of the coalescence filter element 6′ into an inlet space 17′ and an outlet space 18′ by the diagonal separation wall 19′ requires a complex seal between the coalescence filter element 6′ and the housing base 1′ of the combination filter. The seal is attained with a conventional O-ring 20′, whereby the groove receiving the O-ring 20′ is formed so that the plane formed by the O-ring 20′ is not oriented perpendicular to the longitudinal axis 21′ of the combination filter (see FIG. 3).

A drainage valve 22′ is integrated in the lower part of the housing base 1′ and provided with a fill level sensor. The fill level sensor causes the drainage valve 22′ to open at a certain oil fill level of the oil filtered from the compressed air by the coalescence filter element 6′, whereby the oil can be discharged formed the combination filter.

FIG. 4 shows a third embodiment of a combination filter according to the invention. The construction of this combination filter is different from that of FIG. 2 only in the design of the coalescence filter element 6″. Like the combination filter of FIG. 2, the combination filter of FIG. 4 has a housing base 1″, in which a filter insert 2″ and a drainage valve 22″ are integrated. The filter insert 2″ in conjunction with the housing base 1″ forms an annular inlet channel 3″. The upper end of the filter insert forms an outlet channel 4″. The compressed air to be cleaned flows into the combination filter through the annular inlet channel 3″ formed by the inside of the housing base 1″ and a cylindrical housing component 12″, then through the coalescence filter element 6″ and from there via a support disk 14″, which is integrated into the coalescence filter element 6″, into the activated charcoal filter element 9″, before exiting the combination filter through the outlet channel 4″.

In the embodiment of a combination filter according to FIG. 4, the coalescence filter element is provided with a cylindrical filter jacket 23″. The compressed air to be cleaned flows almost through the entire surface of the filter jacket 23″, whereby the oil aerosols contained in the compressed air are caught when flowing through the filter material of the filter jacket 23″, then coalesce into larger oil droplets and drip down through an opening in a lower cover 24″ of the coalescence filter element 6″ due to their weight. The coalescence filter element 6″ is directly connected to the activated charcoal filter element 9″ via an upper cover 25″, in which the support disk 14″ is also integrated. A coalescence filter element with a relatively large filter surface can be easily produced with the cylindrical filter jacket 23″. In addition, the surface of the filter jacket 23″ can be easily enlarged/decreased at the expense/to the advantage of the activated charcoal filter element 9″, so that the volume flow capacity of the combination filter and the adsorption capacity of the coalescence filter element can be flexibly adapted to one another.

The structural and functional details of the aforedescribed exemplary embodiments can not only be used in the explicitly disclosed combination, but they can be applied in any conceivable combination with other combination filters according to the invention. For example, all details of the individual filter elements described with reference to the exemplary embodiment of FIG. 1 can also be used with the combination filter illustrated in FIG. 2.

What is claimed is:

1.-9. (canceled)

10. A combination filter, comprising:
a housing having an inlet and an outlet for a fluid to be cleaned;
a coalescence filter element; and
a processing filter element,
wherein the coalescence filter element and the processing filter element are arranged in the housing such that the fluid, after the fluid has entered the housing through the inlet, flows through the coalescence filter element and the processing filter element sequentially, before the fluid exits the housing again through the outlet.

11. The combination filter of claim 10, wherein the processing filter element is implemented as an oil vapor adsorber filter element.

12. The combination filter of claim 10, wherein the processing filter element is implemented as an activated carbon filter element.

13. The combination filter of claim 10, wherein the coalescence filter element comprises a plane filter.

14. The combination filter of claim 10, further comprising a particle filter element arranged downstream of the processing filter element.

15. The combination filter of claim 14, wherein the particle filter element is implemented as a plane filter.

16. The combination filter of claim 14, wherein the coalescence filter element, the processing filter element, and the particle filter element are arranged in the housing sequentially, with the coalescence filter element being arranged lowermost in the housing.

17. The combination filter of claim 14, further comprising an insert interchangeably arranged in the housing, wherein at least one member selected from the group consisting of the coalescence filter element, the processing filter element, and the particle filter element, is integrated in the insert.

18. A coalescence filter element for use with a combination filter, comprising:
a housing having a tubular shape, said housing having first and second open ends, with one of the first and second open ends being configured as a connection for attachment to a processing filter element;
a coalescence filter material closing the other one of the first and second ends of the housing, and
a separation wall extending diagonally across the housing to separate the first and second open ends.

19. The coalescence filter element of claim 18, wherein the coalescence filter material is implemented as a plane filter which defines a filter plane in parallel arrangement to a plane formed by the connection.
